(19) United States
(12) Patent Application Publication
(10) Pub. No.: US 2009/0041404 A1
(43) Pub. Date: Feb. 12, 2009

(54) Fiber sensor production

(75) Inventor: Paul R. Stoddart, Victoria (AU)

Correspondence Address: KNOBBE MARTENS OLSON & BEAR LLP, 2040 MAIN STREET, FOURTEENTH FLOOR, IRVINE, CA, 92614, US

(73) Assignee: SWINBURNE UNIVERSITY OF TECHNOLOGY, Victoria (AU)

(21) Appl. No.: 11/631,663

(22) PCT Filed: Jul. 8, 2005
(86) PCT No.: PCT/AU2005/001001

§ 371 Date: May 22, 2008

(30) Foreign Application Priority Data
Jul. 8, 2004 (AU) 2004903771

(51) Int. Cl. G02B 6/04; B29D 11/00

(52) U.S. Cl. 385/12; 65/445

(57) ABSTRACT

The invention relates to a method of generating an ordered deposition geometry on a surface of a compound optical fibre, which comprises: (a) arranging a plurality of optical fibres and/or compound optical fibres in common orientation and close packed configuration to form a bundle; (b) drawing the bundle under suitable conditions to produce a compound optical fibre of desired diameter; (c) processing the compound optical fibre to produce a substantially planar surface; (d) subjecting said surface to an etching agent to produce surface relief (e) subjecting said surface with relief to metal coating. The invention also covers a compound optical fibre having an ordered deposition geometry on a substantially planar surface that is substantially transverse to compound optical fibre longitudinal axis, wherein the compound optical fibre comprises individual optical elements of less than about 1000 nm in diameter.

### FIELD OF THE INVENTION

The present invention relates to a method of generating an ordered deposition geometry on a transverse surface of a compound optical fibre, to the compound optical fibres so produced, to a sensor for detecting chemical or biological agents comprising the compound optical fibre as well as to a method of detecting chemical or biological agents utilising the sensor.

### BACKGROUND OF THE INVENTION

The new science of nanotechnology has largely been driven by the unique and often unexpected properties of aggregates of atoms and molecules on the mesoscale (between one and a few hundred nanometers)¹. There is a great deal of interest in exploiting the new properties and behaviour of single materials or combinations of components to generate so-called smart structures or systems. Given that the physical properties of smaller devices are generally more susceptible to alteration, they are particularly attractive for sensing applications². In particular the size-dependent optical properties of metallic nanoparticles offer useful opportunities for chemical sensing.

The localised surface plasmon resonance (LSPR) has been described as the signature optical property of metallic nanoparticles³. This phenomenon occurs when nanoparticles of certain metals (primarily silver, gold and copper) are illuminated with light of appropriate wavelength to excite collective oscillations in the plasma of conduction electrons. One of the consequences of the LSPR is the generation of an enhanced electromagnetic field in the near surface region of the nanoparticle. The amplified electromagnetic field contributes to the significant enhancements observed in surface enhanced spectroscopies^{4, 5}. As such, surface enhanced Raman scattering (SERS) is perhaps the best known of the many interesting effects associated with the LSPR⁶.

Raman scattering is observed when light is inelastically scattered by vibrating molecules, resulting in a shift to both higher and lower frequencies. Scattering may, for example, be enhanced by a factor greater than 10⁶ for molecules adsorbed on a surface containing gold or silver nanoparticles. In this way, even 1% of a monolayer of molecules adsorbed at a SERS-active surface may be detected. The Raman-active vibrational frequencies of the molecules provide a characteristic fingerprint for the species present and a sensitive probe of the molecular environment. Raman spectroscopy is uniquely suited to investigate samples of virtually any kind, including gases, solutions, solids, and both clear and turbid media and it has potential applications in any area where chemical measurements are made, including industry, medicine, biochemistry and the environment. For example, optical fibre sensors and measurement systems have made a significant contribution to on-line monitoring of industrial processes, as well as advanced diagnostic and therapeutic techniques. The size-dependent properties of metal nanoparticles are currently attracting a great deal of research interest and other applications are bound to be developed in future.

One aspect that has hindered the utility and further development of Raman spectroscopic techniques is that traditional types of substrate used for SERS have tended to contain a wide distribution of particle sizes, which exhibit generally poor reproducibility and stability. The distribution of particle sizes is believed to reduce or mask the expected particle-size dependence of the peak excitation wavelength (λₘₐₓ) for the LSPR⁴. Ordered nanostructures with substantially uniform size distributions therefore comprise an attractive class of substrates. Improved preparation of SERS substrates, together with progress in spectroscopic techniques, has driven renewed interest in the field⁶.

A variety of techniques for building structures smaller than 100 nm have been proposed. Regular arrays of silver particles have been deposited on silica posts that were fabricated by standard techniques of photolithography⁷. More recently, e-beam lithography has been used to obtain a greater variability in the structural parameters of particle arrays⁸. However, the limited resolution of the former technique and the high sample cost of the latter have limited their use. A technique known as nanosphere lithography comprises an alternative “bottom-up” approach³. In this case, a metal film is deposited over a self-assembled periodic array of polymer nanospheres. Triangular metal nanoparticles are formed on the substrate through the interstices of this mask and remain on the substrate after the nanospheres are removed. Particles with diameters in the range 20-1000 nm can be obtained, which comfortably covers the size distribution suitable for SERS. Moreover, the SERS signal can be optimised for a particular target molecule by changing the nanoparticle aspect ratio and local dielectric environment⁹. All of the above methods for generating SERS substrates have confirmed that improved and reproducible SERS enhancements can be obtained with optimised periodic structures.

Improvements in the preparation of LSPR systems are of particular interest for the development of optical fibre sensors. The use of optical fibres to deliver the laser beam to the sample and to collect the resulting Raman signal has allowed the on-line monitoring of industrial processes¹⁰. It has been recognised that the combination of fibre-optic probes with the high sensitivity and specificity of SERS potentially allows powerful chemical sensors with low cross-sensitivities¹¹. In general, reproducible and tunable SERS-active fibre probes would have a number of additional advantages for the development of chemical sensors, as follows:
(a) The small size and flexibility of optical fibres allows highly localised and minimally invasive monitoring as the fibre diameter can in principle be made extremely small (e.g. less than 10 μm). The low cost and non-invasive nature of the probe element allows contaminated or faulty sensors to be conveniently replaced. This also implies that the main difficulty with conventional transducers may be avoided, in that completely reversible bonding of the detectable particle to the sensor-active coating and completely irreversible chemical bonding of this sensor-active coating to the transducer is not necessarily required². In some cases, aspects of the SERS spectrum itself may provide a convenient internal measure of sensor performance and data integrity.
(b) Raman spectroscopy is a highly specific transduction method for monitoring changes in chemical composition and identifying multiple analytes. Raman spectroscopy is particularly effective with organic compounds and in an aqueous environment. A reproducible SERS effect should allow more accurate quantitative measurements of concentration.
(c) A variety of ultrathin surface layers can be applied to individual sensors in order to tailor their response. In this way trace analytes can be concentrated by selectively adsorbing receptor molecules¹³, by hybridisation to complementary DNA sequences¹⁴ or by selective partition layers¹⁵. An array of different sensors can readily be assembled as demonstrated in Ref. 20. Optical fibres are amenable to the development of sensor assemblies with multiple transduction modes, while bundles of fibres could be used for chemical imaging or for screening large libraries of different compounds.

These advantageous properties may allow SERS to be used for routine high-throughput analyses.

In the past, Raman spectroscopy required bulky but delicate equipment to acquire the relatively weak signal. A number of technological improvements over the last decade have combined to enable the development of increasingly compact, rugged and automated Raman instrumentation¹⁰. A compact, reliable laser source and scientific charge-coupled device (CCD) detector are now typically combined in a fibre-coupled instrument. These factors, together with the inherent advantages of the Raman technique, have led to its rapid deployment in a wide range of chemical measurement applications.

Indeed, it is not only in the context of Raman spectroscopy that fibre optic sensing elements that have ordered deposition geometries on their tips may be useful. There are at least four other known nanoparticle-based sensing mechanisms that can transduce chemical interactions into optical signals. These are based on changes in the LSPR extinction or scattering intensity, shifts in the maximum wavelength (λₘₐₓ) of the LSPR, or combinations of these (see Ref. 16 and references therein). Haes and Van Duyne have demonstrated that the LSPR λₘₐₓ of silver nanoparticles—obtained via nanosphere lithography on glass substrates—can shift in response to local refractive index changes and charge-transfer interactions¹⁶. They claim that an extremely sensitive and selective nanoscale sensing mechanism can be achieved in this way. The wavelength shifts can be observed using simple equipment for UV-visible extinction spectroscopy, which would greatly facilitate field-portable environmental or diagnostic applications.

Researchers have successfully used a variety of methods to generate inhomogeneous SERS-active fibre tips^{11, 17, 18}. However, the limited available data suggests that the sensor-to-sensor reproducibility of these devices is rather poor. Within the same batch of sensors, Viets and Hill report standard deviations in SERS intensity ranging from 20% to 42% for various preparation methods¹¹. The situation can be improved by immobilising colloidal silver particles on the fibre tip¹⁷. This yields a variability of approximately 10% at the 95% confidence level, which is still considered insufficient for general analytical use.

The nanosphere lithography approach of Ref. 3 is based on U.S. Pat. No. 4,407,695 to Deckman and Dunsmuir, which discloses a method of producing a lithographic mask on a surface of a substrate that involves coating the substrate with a monolayer of colloidal particles and then using the monolayer of colloidal particles as an etch mask for forming an etched pattern in the substrate. In this case the formation of an ordered array of the colloidal particles on the substrate was achieved by rotating the substrate in a horizontal plane about an axis normal to the surface. While this approach may be effective for lithography of planar surfaces such as on glass, mica or silicon wafers the present inventor has determined that it is unsuitable for the coating of transverse surfaces of optical fibres or other similar materials.

The teaching of Micheletto et al¹⁹ discusses methods for depositing layers of small spheres on macroscopic planar substrates which involves inclining the surface at an angle of approximately 9° to the horizontal so that the liquid evaporates along an interface that moves gradually from top to bottom of the sloping surface. This uniformity of the drying process induces the spheres to adopt a uniform close packed arrangement. While this approach may be suitable for obtaining a uniform close packed array of microspheres on a macroscopic planar surface, such as a surface of a silicon or glass wafer it is not a suitable process for obtaining an ordered deposition geometry on an optical fibre tip or on other surfaces of similar scale.

To date none of the optimised periodic SERS structures have been successfully exploited in the context of optical fibre systems. In view of the minute scale of the transverse surface of optical fibres (the optical fibre tip) and the need for substantially uniform and reproducible geometry to be deposited on these surfaces for the purposes of Raman spectroscopy or other optical measurements, it is clear that significant technical barriers have restricted the useful adoption of standard lithography techniques. It is in this context that the present inventor has conceived methods of generating ordered deposition geometries on the fibre tips of optical fibres. Although other methods are known for generating LSPR effects on the tip of an optical fibre, the approach described by the present inventor is unique and may offer various advantages (e.g. reproducibility, stability, low cost production) over existing techniques. The approach adopted by the present inventor also has the benefit that it gives rise to compound optical fibres that comprise a fused bundle of smaller fibres. The compound optical fibre can be configured in such a way that a number of parallel optical measurements may be conducted on a single sample.

### SUMMARY OF THE INVENTION

According to one embodiment of the present invention there is provided a method of generating an ordered deposition geometry on a surface of a compound optical fibre, which comprises:
(a) arranging a plurality of optical fibres and/or compound optical fibres in common orientation and close packed configuration to form a bundle;
(b) drawing the bundle under suitable conditions to produce a compound optical fibre of desired diameter;
(c) processing the compound optical fibre to produce a substantially planar surface;
(d) subjecting said surface to an etching agent to produce surface relief;
(e) subjecting said surface with relief to metal coating.

In a preferred embodiment steps (a) and (b) are repeated consecutively 1 to 4 times prior to conducting step (c).

In another preferred embodiment the method includes a step of cleaving and/or grinding optical fibre and/or compound optical fibre to desired length.

In one preferred embodiment of the invention the substantially planar surface is substantially transverse to compound optical fibre longitudinal axis.

In one preferred embodiment of the invention an optical fibre compatible support of desired configuration is used to retain optical fibres and/or compound optical fibres in step (a). Preferably the support comprises a silicate glass.

In another preferred embodiment of the invention the support retaining optical fibres and/or compound optical fibres is collapsed under heat and/or vacuum to form the bundle.

In a preferred embodiment of the invention processing to produce the substantially planar surface comprises cleaving and/or grinding.

Preferably the etching agent is an acid or alkaline solution. Preferably the etching agent comprises at least one of hydrofluoric acid, hydrochloric acid, acetic acid, sulfuric acid, citric acid, boric acid, nitric acid, phosphoric acid, benzoic acid, butanoic acid, carbonic acid, formic acid, hydrogen sulfide, hydrocyanic acid, oxalic acid, perchloric acid, potassium hydroxide, phosphoric acid, propanoic acid, trichloro acetic acid, sodium hydroxide, hydrogen peroxide, magnesium hydroxide, potassium hydroxide, ammonium fluoride or ammonia.

Preferably the surface is subjected to the etching agent for a period of between about 5 seconds and about 10 hours, preferably between about 10 seconds to about 2 hours, more preferably between about 20 seconds to about 40 minutes, still more preferably between about 30 seconds and about 10 minutes and most preferably between about 1 minute and about 5 minutes. Preferably there is a quenching step after the surface has been exposed to the etching agent. In a preferred embodiment the quenching step involves rinsing with distilled water. The quenching may be assisted by agitation in an ultrasonic bath.

Preferably the metal utilised in the metal coating step comprises at least one of gold, silver, copper, aluminium, platinum, lithium, indium, sodium, zinc, gallium or cadmium. Preferably the metal is coated onto the surface in a thin film, in a matrix formation or in discrete particles.

It is preferred that the metal layer has a thickness of between about 10 nm and about 1 μm, preferably between about 50 nm and about 500 nm and most preferably between about 80 nm and about 300 nm.

In another preferred embodiment of the invention the surface with relief is coated with multiple layers of metal. Preferably a layer of chrome is applied to the surface with relief to improve adhesion to the surface of subsequent metal layers.

In one embodiment of the invention metal is deposited at high points of the surface with relief. In another embodiment of the invention metal is deposited at low points of the surface with relief.

In a further preferred embodiment of the invention a metal layer coated on the surface with relief is functionalised to allow chemical binding to analyte specific agents.

In a further preferred embodiment of the invention the metal layer coated on the surface with relief is functionalised with an agent that selectively concentrates a target analyte or analytes at the sensor surface.

Preferably the compound optical fibre with ordered deposition geometry on a surface thereof is coherent, and preferably individual optical elements of the compound optical fibre have diameter less than about 1000 nm, preferably less than about 500 nm and most preferably less than about 300 nm. Preferably the compound optical fibre produced according to the methods of the invention is an optically homogenous waveguide.

According to another embodiment of the invention there is provided a compound optical fibre having an ordered deposition geometry on a substantially planar surface that is substantially transverse to compound optical fibre longitudinal axis, wherein the compound optical fibre comprises individual optical elements of less than about 1000 nm in diameter.

According to another embodiment of the invention there is provided a compound optical fibre with an ordered deposition geometry on a substantially planar surface thereof, produced by the methods outlined above.

According to another embodiment of the invention there is provided a compound optical fibre having an ordered deposition geometry on a substantially planar surface thereof, for use as a sensor of chemical and/or biological agents.

According to a further embodiment of the invention there is provided a sensor of chemical and/or biological agents comprising a laser or broadband light source, a spectrometer and a photodetector that are in optical communication with a compound optical fibre having an ordered deposition geometry on a substantially planar surface thereof.

### BRIEF DESCRIPTION OF THE FIGURES

The invention will be further described with reference to the figures, wherein:

FIG. 1 provides a schematic representation of the production of a standard imaging fibre, where the number of individual fibres (1) may be as large as 100,000 or more. In this example, the fibres are assembled in a tubular support of compatible material (2). After the preform bundle has been softened by a heat source (3), it is drawn to a fine fibre (4) and wound onto a mandrel. After drawing, the individual fibres are fused together and, for imaging purposes at visible wavelengths, they form an array of pixels (6) of diameter larger than 2 μm.

FIG. 2 provides a schematic representation of the assembly of a compound fibre from a collection of imaging fibres (7) placed in a tubular support of compatible material (2). After drawing, the individual imaging fibres are fused together and reduced in dimension (8). This process can be repeated several times until the pixels (6) of each imaging fibre are reduced to the required scale, which is typically smaller than 1 μm. Where the drawn compound fibre (9) comprises a single homogeneous light guide, a planar transverse surface (10) of the compound fibre can be etched to form a sensor surface, for the purposes of the present invention.

FIG. 3(a) shows a schematic of an array of optical fibre sensors. In this case, the individual sensor elements (10) each comprise a single homogeneous light guide and are mechanically bound by a polymeric sleave (11).

FIG. 3(b) shows a schematic of an array of optical fibre sensors produced by a second approach, where the individual sensor elements (10), each comprising a single homogeneous light guide, have been fused together in a drawing process similar to that described in FIG. 2. In this case the sensor elements have been placed within additional tubular sheaths of compatible material that are also fused together and are used to maintain the light guiding nature of the sensor elements or absorb stray light within the fibre optic material (12). The individual sensor elements occupy distinct, uniquely addressable locations on the planar transverse surface of the compound array fibre.

FIG. 4 shows the topographic relief that is obtained on the planar transverse surface of a compound fibre after etching. In this example, the individual pixels have been eroded to form a multiplicity of concave pits (13), each of diameter less than 1 μm.

FIG. 5(a) shows a scanning electron microscope (SEM) image of the tip of a drawn fibre etched using a solution of 20% HF in deionised water, showing the resultant regular “honeycomb” structure. The imaging elements have been reduced to a diameter of about 320 nm.

FIG. 5(b) shows an SEM image of the tip of a drawn fibre etched using a solution of NH₄F:HF:HCl:H₂O in relative amounts (by volume) of 5:1:14:23, showing the resultant regular “honeycomb” structure. The imaging elements have been reduced to a diameter of about 300 nm.

FIG. 6(a) shows the SERS spectrum of thiophenol obtained using the fibre tip prepared according to example 1, using etching agent (a).

FIG. 6(b) shows the SERS spectrum of thiophenol obtained using the fibre tip prepared according to example 1, using etching agent (b).

FIG. 7 shows a schematic of a simple optical fibre probe system that allows efficient collection of Raman scattered light and convenient interchange of probe fibre, while reducing the fibre Raman background

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

Reference within this specification to prior patent documents or technical publications is intended to constitute an inclusion of the subject matter of such prior publications within the present specification in their entirety, by way of reference.

The present invention can be adopted for generating an ordered surface deposition geometry on the tips of optical fibre. By the phrase “ordered surface deposition geometry” it is intended to imply the formation of surface features that are repeated and are substantially consistent in size and shape across the surface concerned.

By reference to “optical fibre tips” or “fibre tips” it is intended to embrace the transverse surface of the optical fibre. That is, a surface that is preferably substantially perpendicular to the elongate or axial direction of the fibre. In its broadest sense the methods of the invention involve forming a bundle of optical fibres and/or compound optical fibres, drawing the bundle under appropriate conditions to produce a compound optical fibre of desired diameter, processing the compound optical fibre to produce a substantially planar surface that is preferably (although not necessarily) substantially transverse to compound optical fibre longitudinal axis (ie. a fibre tip), subjecting the surface to etching to produce surface relief and subjecting the surface with relief to coating with metal.

Throughout the remainder of this specification it should be understood that where the context allows, reference to applying methods of the invention to optical fibre is intended to encompass the application of the methods also to other elongate articles having similar characteristics, such as rods and filaments that may for example be produced from materials that may be drawn under appropriate conditions, such as glass, ceramics, polymers, fused silica, silica composites and the like.

Inexpensive fused-silica fibres are well suited to Raman spectroscopy at visible wavelengths, as they show minimal transmission losses and negligible fluorescence. This serves to reduce the background Raman signal from the optical fibre. A preferred and readily available fibre type is an all-silica fibre (also called a silica-silica fibre), where the pure silica core is surrounded by a doped silica cladding. The individual elements in an optical fibre typically comprise a silica core that forms the light guiding region. The silica core is surrounded by a doped silica cladding, which serves to depress the refractive index. This helps to confine the light in the core region. Typical dopants include fluorine or boron. This type of fibre is available from a number of commercial suppliers. In general, a pure silica core is preferred because of its good transmission characteristics in the visible. However, a fibre with a low hydroxyl ion content may be preferred for use in the near-infrared.

In practice, the optical transmission of the optical fibre is not critical for short probe lengths, and background fluorescence signals can be reduced by changing the excitation wavelength. Therefore, Raman spectroscopy may also be performed with optical fibres where the core is doped with germanium or phosphorus in order to raise the refractive index relative to a pure or doped silica cladding. In an alternative preferred embodiment, the doping is arranged so that the refractive index of the core is depressed relative to the cladding. Although this kind of glass fibre would not be useful for guiding light, it may, after further treatment as described below, provide surface relief that is favourable for the purposes of this invention. The methods of the invention may be applied to optical fibres of any diameter, including the common commercial fibres that have diameters between about 2 μm (in prefabricated compound fibres) up to as much as 2 mm individual fibres.

Multi-core optical fibres may be drawn from preform bundles to produce compound optical fibres, such as the commercially available imaging fibres, where the individual elements serve as discrete light guides that transfer individual pixels of an image. Typically the individual elements of these commercial compound fibres have a diameter of 2-5 μm. In contrast, in the present invention the individual elements have diameter less than about 1 μm, preferably less than about 500 nm and most preferably less than about 300 nm. There is no commercially available “image fibre” with these dimensions, primarily because the fibre does not function as an image fibre on this scale. When the individual elements are reduced to a dimension smaller than the wavelength of light, as described herein, the elements become ineffective for guiding light, and the compound fibre comprised of these elements must be considered as a homogeneous optical medium with a single effective refractive index. Therefore a fibre with nanoscale elements cannot be used as a conventional imaging fibre. However, the present inventor has shown that after etching, as described herein, the structures obtained can be used to generate a localised surface plasmon resonance (LSPR) in a thin metal film.

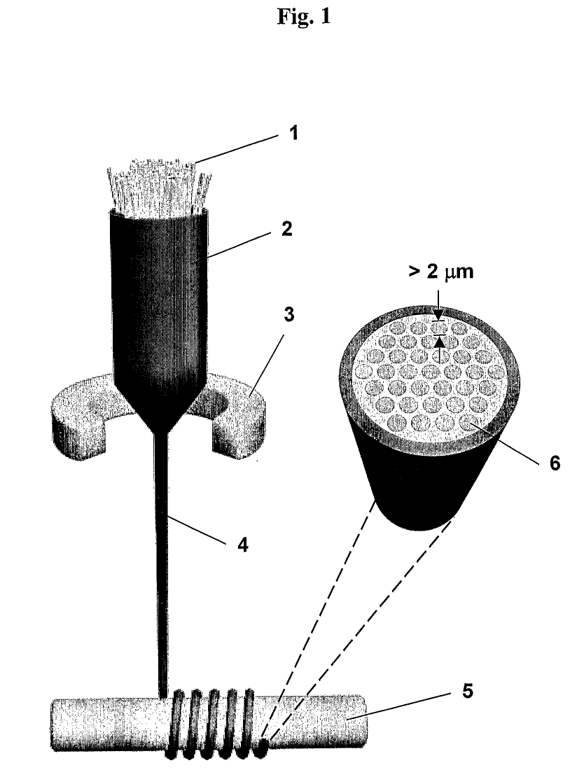

Compound optical fibres are commercially available, which consist of between 1600 and 100,000 individual fibres (picture or imaging elements), each having a typical diameter of about 2-5 μm or even greater. In principle though, compound fibres could consist of any number of individual fibres. Manufacturers include Fujikura, Schott and Sumita Optical Glass, amongst others. The production of an image fibre is illustrated in FIG. 1.

As discussed above, the invention preferably either utilises commercially available compound optical fibres or it involves initial production steps from individual optical fibres to produce compound optical fibres. By the terms “compound optical fibres” or “compound fibres” it is intended to convey that such fibres are multi-core structures that are conglomerates of commonly oriented fibres that have been drawn under suitable conditions, resulting in a fibre of desired diameter essentially formed from the fusing together of a plurality of smaller fibres. Preferably, the compound fibres are coherent, in that opposite ends of the smaller fibres fused to form the compound fibre are located at substantially equivalent locations within the respective fibre tips. That is, the relative positions of each imaging element (pixel) remains substantially constant along the length of the compound fibre, and the bundle from which it is derived. This feature offers the benefit that sensor probes manufactured from different sections along a compound fibre will display substantially equivalent relief, which serves to improve the reproducibility of measurements between the sensors. Where an array sensor is assembled, consisting of several optically isolated compound fibres, then these compound fibres should preferably also be positioned coherently, so that SERS or other LSPR events taking place at one end of the fibre can be read and plotted by position, upon detection at the other end of the fibre. However, the sensor surfaces achieved by this invention are of sufficient quality that they may also find use in situations where conditions permit readings to be made directly on the free side of the metal coated surface.

To ensure optimal results of the methods of the invention and maximum reproducibility the optical fibres utilised should be cleaned and free from dust, moisture, grease or particulate matter as well as of any protective coating (referred to as “buffer”) that may be present, prior to conducting the method. For example, polymer buffers may be removed by mechanical or chemical means. Mechanical stripping can be done with a variety of commercial fibre strippers that utilise appropriately sized cutter blades or a soft cotton thread. Some examples of chemical removal strategies include dipping in a solvent such as methylene chloride, xylene, heated propylene glycol, methyl ethyl ketone or acetone, or dipping in an acid, such as hot sulphuric acid. The strategy employed is dependent on the particular buffer that is present. The fibres may be rinsed after removal from the chemical and preserved in high purity ethanol (for example puriss., >99.8% GC). Methods are also known for stripping metal buffers and silica cladding, although fibres of this kind are unlikely to be preferred choices. For optimal results it may be advantageous to perform a chemical cleaning step after a mechanical cleaning step. For optimal results the processes of the invention should preferably be conducted in a dust-free environment, such as a clean-room.

Prior to commencing the method, and/or after one or more processing steps it may be appropriate to cleave fibres or compound fibres to the appropriate length. This task may be performed using conventional fibre cleaving tools, which are readily available from a number of commercial suppliers and are designed for fibres of most commonly encountered diameters. A benefit of the present invention is that the compound fibres produced may be processed, handled, cleaved, polished, joined etc. using conventional equipment.

An initial aspect of the method according to the invention is to gather together in a common orientation (that is, with all fibres having their longitudinal axis in substantially the same direction) a plurality of optical fibres and/or compound fibres. The process will utilise a plurality of optical fibres to thereby increase the surface area over which the geometry, pattern or array is to be deposited and to increase the concentration of surface features. As the process may be scaled up and mechanised, the upper limit of optical fibres that can be processed is determined by the quantity that the equipment being utilised can accommodate. For example, however, it may be expedient to arrange together between 3 to 1,000 optical fibres and/or compound optical fibres, preferably between 50 and 500 and more preferably between about 100 and about 350 optical fibres and/or compound fibres into a close packed configuration to form a bundle. However, commercial imaging fibres containing as many as 100,000 individual fibres, for example, may also be processed in this way.

In arranging the fibres into a close packed configuration there are a number of approaches that may be adopted. Preferably, the fibres are inserted into a support having desired configuration (for example having circular, square, rectangular or triangular cross-sectional shape, and preferably being tubular), which is made of compatible material. The material should be “compatible” in that it is preferably collapsible under heat and/or vacuum and is able to be heated and drawn without undue degradation and without causing damage to the fibres. Preferred materials include glass, plastics and fused silica.

In the case where a support is used the support is preferably substantially filled with fibres. A close packed configuration may be achieved, that is with minimal free space between fibres that are preferably in an hexagonal close-packed arrangement, by subjecting the support and its contents to heat and/or vacuum or partial vacuum conditions. This will result in collapsing of the support, forcing the fibres to adopt a space saving configuration. The arrangement of close packed fibres (which may include individual fibres and/or compound fibres) is referred to herein as a “fibre bundle”. In the present invention, the support will also serve a cladding function (i.e. a light guiding purpose) by confining the excitation and scattered light signals within the core of fibres. Therefore, a preferred support would have a lower refractive index than the material making up the core region. In addition, the respective diameters of the support and the core can be varied over a wide range, which provides great flexibility in the final size of the fibre and the sensitive region.

Once the fibres have been arranged to form a bundle it may be appropriate to process their tips to form a common planar surface, although this step may instead or additionally be conducted at other points in the overall method, such as preferably following drawing of the bundle to produce the compound fibre. Although the planar surface will normally be as close to perpendicular to the axis of the fibres as possible, in applications where it is favourable for optical measurement purposes the surface normal of the planar surface may be inclined by up to around 60° from the longitudinal axis of the fibres, but more likely by 3° to 15° from the longitudinal axis.

Processing of the optical fibre bundle or compound to produce a planar surface may involve a number of alternative approaches. Firstly, if the optical fibres have individually been accurately formed to have tip surfaces perpendicular to their longitudinal axis, and if these fibres have been accurately arranged such that the tip surfaces are within the same plane, then in forming the common planar surface it may be unnecessary to take further action, apart perhaps from some fine polishing. More likely, however, the common planar surface will be formed by cleaving (cutting), grinding and/or polishing the fibre bundle or fibre compound as a whole to produce a continuous and even plane, which is preferably substantially transverse to the longitudinal axis of the fibres.

Grinding and polishing may be performed using a series of increasingly fine polishing films, such as for example a sequence of 9 μm, 3 μm, 0.3 μm and 0.05 μm aluminium oxide lapping films, in order to achieve the required surface smoothness. A similar sequence of polishing with diamond paste can also be used in order to increase the rate at which material is removed from the surface, although this approach still relies on a final polishing with, for example, 0.05 μm aluminium oxide particles, as diamond particles are not commonly available in this size. An alternative polishing approach is based on a combination of chemical etching and mechanical abrasion. A typical chemical mechanical polishing procedure for oxides is based on a slurry consisting of a fumed silica abrasive suspended in an ammonia or potassium hydroxide environment that is buffered to prevent pH drift. The advantage with this polishing process is that silica is softened at high pH's and is easier to remove.

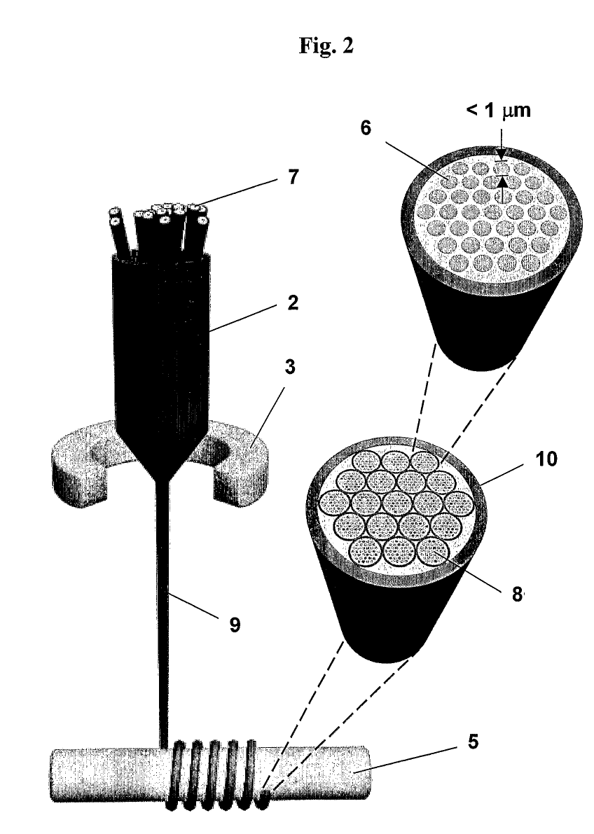

The bundle may be drawn under conventional conditions, which involve heating the bundle and with consistent force drawing from an end of the bundle semi-solid material, with the result that a fine fibre or filament of consistent diameter is produced, as shown in FIGS. 1 and 2. The capacity of glass fibres to accurately maintain the cross-sectional structure over large changes in diameter during drawing is well known. Commercial fibre drawing facilities are able to draw a pre-formed bundle down to a well-controlled diameter, thereby providing the precise size required for the individual fibres. In this way the diameter of the individual fibres within the bundle can be reduced to nanometre scales, a regime that is difficult, if not impossible, to achieve using traditional micromachining or microlithography processes. The result of the drawing step is the generation of a compound fibre that comprises a conglomerate of smaller diameter individual fibres that are fused together. Following drawing the end of the preform would typically be discarded, as it would be mechanically held by some kind of pulling device. The pulling device exerts a controlled tension on the softened glass, thereby allowing the preform to be drawn to the desired diameter.

The individual fibres may be fixed into position inside the support (in this case in the form of a tube) by fusing the bundle (using heat) from the end/s to hold the fibres together. The fused ends are then mechanically held to initiate drawing. This approach is known as the rod-in-tube method of assembling a preform and has been the subject of several patents over the years (as referred to in U.S. Pat. No. 6,711,918).

Gaps between the fibres may simply be filled up by the natural flow of the semi-liquid glass. Alternatively, an additional cladding of lower viscosity may be used, which flows at a lower temperature than the image fibres and therefore fills up the gaps and/or promotes adhesion between the individual components (see U.S. Pat. No. 4,011,007). It is possible that the structures obtained in the etched fibre in the examples that follow are in fact due to the presence of this lower viscosity material around the silica glasses of the picture elements, rather than due to the fluorine-doped cladding, as has been suggested elsewhere herein. In a further approach, a gaseous “surface treating agent” is made to flow through the clearance between the rods and support tube at a high temperature. This helps to fuse the components together at high temperature (see U.S. Pat. No. 4,264,347 and U.S. Pat. No. 4,668,263). In this approach it is important to prevent gas bubbles from being trapped between the rods, as these can cause significant losses in transmitted light.

A “bare” bundle of fibres (i.e. a bundle that is directly clamped at the fused ends but does not have a support) may also be drawn, although such a fibre is weaker than those produced with a support.

A typical range of draw parameters for silica fibre bundles is adopting a drawing temperature of 1850-2000° C. (such as might be achieved in an annular electric furnace) and draw speeds of between about 0.5 to about 20 m/min. The draw variables are dependent on each other. The speed mainly depends on equipment capability (motors, thickness monitor, etc) and relates to preform and fibre diameter (mass conservation). Temperature is established in a similar way as for a standard draw; too high a temperature causes instability (viscosity too low), excessive diffusion of dopants and deformation, while too low a temperature causes the fibre to break (tension too high). The first description of a drawn, fused bundle of fibres for use in imaging, is attributed to N. S. Kapany in 1965 (U.S. Pat. No. 3,190,735). Before this, bundles were assembled from fibres of the desired final diameter, which were simply clamped together at the ends.

Proper alignment of the elemental image fibres (or rather rods in the preform) is typically achieved by careful manual assembly. However, U.S. Pat. No. 4,397,524 describes a method where water is made to flow through the supporting tube, together with rotation (the support tube may be mounted on a lathe) and/or ultrasonic vibration, which causes the fibres/rods to pack into a regular, aligned pattern.

Some image fibres are constructed with an extramural absorber, which reduces leakage of light between neighbouring picture elements in imaging applications. These image fibres are of lesser interest in the current invention, due to the additional light losses that will be introduced by these absorbers when the scale is reduced. However, these losses may not be significant over short sensor lengths.

Once a compound fibre comprising a conglomerate of smaller diameter fibres has been obtained, the steps of gathering a plurality of optical fibres and then drawing the resultant fibre bundle may be repeated separately or consecutively a number of times. This would serve to achieve two main objectives:
a). further reduction in the diameter of the individual fibres to achieve a desired scale, while maintaining the overall diameter of the compound fibre at a preferred value (see FIG. 2);
b). allow preferred sensor geometries to be obtained, in particular array geometries.

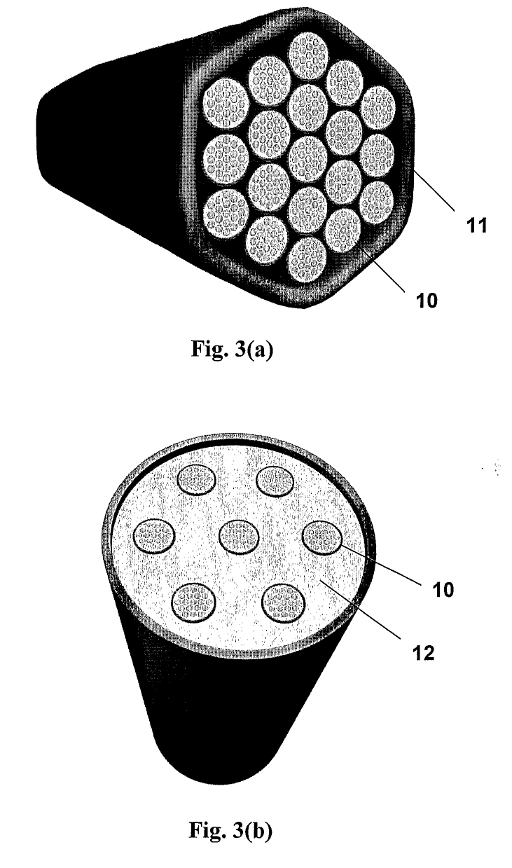

The first objective is clear, given the size-dependence of the optical properties that are exploited in this invention. At the same time, it may be preferable to maintain a standard outer diameter of the compound fibre (such as 125 μm, for example), so that the resultant fibre is easily processed with standard fibre tools. The second objective is discussed further below, in the context of examples given in FIGS. 3(a) and 3(b).

The preparation of sensor arrays for parallel measurements of multiple analytes is an area of growing importance, given significant applications in drug screening and proteomics. These are areas where chemical or biological interactions occurring over massive libraries of compounds are of interest for developing new therapies and diagnostic tests. Array measurements may also be useful in applications where complex mixtures of compounds need to be analysed e.g. odours, food, environmental monitoring. In the context of the present invention, sensor arrays may be obtained by assembling bundles of compound fibres, provided that each compound fibre is able to guide light without interference from neighbouring compound fibres. The number of elements in an array can in principle range from 2 up to the 100,000 fibres found in commercial image fibres. At the same time, a variety of functionalities must be achieved on each of the sensor elements, in order to perform the desired range of measurements. This may be achieved in at least two basic ways described below.

Firstly, individual compound fibres may be gathered into a plurality of bundles, each of which is arranged into a close packed configuration. Each bundle is then treated as a batch to attach a different analyte specific agent to the sensor ends of the fibres comprising that bundle. Fibres, or groups of fibres, are then separated from different bundles and combined in a new bundle to produce an array of sensors, according to the prescriptions of Ref. 20. In this way, each fibre or group of fibres within the array can be discretely addressed to an optical detector or detectors. Each fibre or group of fibres has a different characteristic response to different components of a test sample. This provides unique patterns of response, which allow rapid sample identification by the sensor.

There are a number of approaches that may be adopted to gather fibres into bundles for batch processing, given the need for subsequent separation. In locating the fibres to be processed in a common orientation the fibres may be positioned so that the tips that are to form the surface for deposition are located at or about a common plane. By ensuring the tip surfaces are positioned at approximately the same plane in space it may be possible to minimise the amount of grinding or polishing, should this be required to form a common planar surface to which the deposit can be uniformly applied. In order to perform grinding or polishing, the commonly oriented fibres must be fixed rigidly with respect to each other and to the polishing surface. To achieve this, the commonly oriented fibres may be held mechanically, such as by a circumferential tie or by wrapping with a compatible polymeric film, as shown in FIG. 3(a). Alternatively they may be dipped into or otherwise coated with a compatible solidifying liquid or adhesive material, such as natural or artificial resins, polymers or waxes exhibiting properties sensitive to chemical or thermal change. A preferred material that may be used is a thermoplastic polymer known as Crystalbond™, which is commercially available from Aremco Products, Inc. This material provides excellent adhesion to glass and flows at a temperature of 77° C., at which point its viscosity is 6000 cps. On heating, the adhesive readily dissolves in acetone or methyl ethyl ketone.

Alternatively the individual fibres that make up the fibre bundle may be individually cleaved and then positioned in such a way as to generate the planar surface. Once the fibres in the fibre bundle have been located at a common planar surface and have a sufficiently smooth surface finish, the bundle can proceed to the etching, metal coating and functionalisation stages described below. In order to minimise the potential for damage to the sensor surface once the coating stages are completed, it is preferred that the commonly oriented fibres now be held mechanically, such as by a circumferential tie or by wrapping with a compatible polymeric film.

The second way in which bundles of compound fibres may be produced, while ensuring that each compound fibre is able to guide light without interference from neighbouring compound fibres, is shown in FIG. 3(b). In this approach, the image fibres or compound fibres are separated from each other by regions of reduced refractive index in the preform bundle, so that after drawing each image fibre or compound fibre within the array can be discretely addressed to an optical detector or detectors. The drawing process leads to a monolithic structure with an array of sensor regions. Where commercial image fibres are used, it may be necessary to place the fibres inside a cladding tube of reduced refractive index. Where compound fibres are used, the support tube used to produce the compound fibre can be chosen to provide the required diameter and refractive index profile. After drawing, the fibre array is cleaved or polished and then etched, coated with metal and functionalised. In order to obtain different functionalities at different locations in the monolithic array, this approach requires a site-selective deposition method. In a preferred embodiment, this is achieved by means of photoactivatable attachment linkers or photoactivatable adhesives or masks. In this way, defined regions of functionality may be produced in a sequential fashion at selected sites on the array.

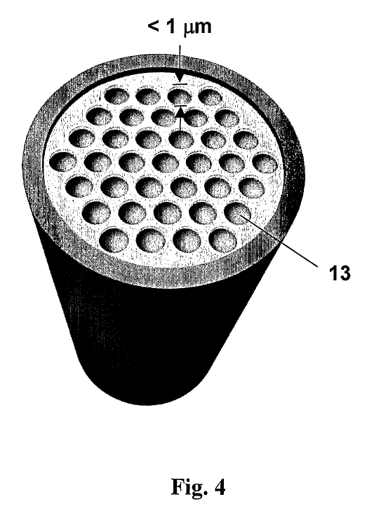

Once any necessary processing has been conducted to generate a fibre tip, the fibre tip can be subjected to the etching process. As the compound fibre may be coated with a conventional protective buffer coating following the drawing step, it will be necessary for this coating to be removed in the vicinity adjacent to the fibre tip prior to the etching. The etching step involves exposing the fibre tip to an etching agent that dissolves the core material of the individual fibres at a different rate than it dissolves the cladding of each individual fibre. As a result of this preferential etching a “honeycomb” type structure is created, such that the surface has relief. In this context the term “relief” is intended to mean that the surface is contoured, such as with a series of repeated and substantially consistently shaped and sized pits, as shown in FIG. 4, or protuberances and surrounding borders. The pits or protuberances correspond to the core material of the individual fibres and the borders correspond to the material surrounding the core of the individual fibres. Pits result when the core etches at a faster rate than the cladding, while protuberances result when the core etches at a slower rate than the cladding. The etch rate of pure and doped silicate glasses is a complex function of several factors, including the dopant concentration, density, dopant species and stress. Therefore the detailed topography can be tailored by judicial choice of dopants in the core and cladding regions.

The fibre tip may be exposed to the etching agent for example by dipping the tip into an etching agent solution, by using a syringe or dropper to apply etching agent to the fibre tip or by other routine approaches. Preferably the fibre will be clamped in position during this operation to avoid the potential for damage through contact with containers, other implements or the like. At the same time, provision may be made to agitate the fibre or the etchant and thereby promote more uniform etching e.g. by sonication or stirring.

Preferred etching agents include aqueous acid or alkaline solutions using substantially particulate free distilled water. Examples of preferred etching agents include hydrofluoric acid, hydrochloric acid, acetic acid, sulfuric acid, citric acid, boric acid, nitric acid, phosphoric acid, benzoic acid, butanoic acid, carbonic acid, formic acid, hydrogen sulfide, hydrocyanic acid, oxalic acid, perchloric acid, potassium hydroxide, phosphoric acid, propanoic acid, trichloro acetic acid, sodium hydroxide, hydrogen peroxide, magnesium hydroxide, potassium hydroxide, ammonium fluoride or ammonia, or combinations of these. Vapours of some of these compounds are also known to be effective etchants. Other possible etching methods include reactive ion etching or inductively couple plasma etching, where gaseous compounds containing carbon and halogens such as fluorine, chlorine or bromine are typically used to produce the plasma. Processing equipment and a number of commercial etchants, which have varying degrees of efficacy in glass etching, are also available from companies such as Surface Technology Systems, Ashland, Transene and Cyantek.

Suitable substantially particulate free distilled water may comprise purified microfiltered water, that may optionally include further additives such as surfactants. For example the water utilised will preferably have a resistivity of 10 MΩ or greater, particularly preferably at least 15 MΩ and most preferably around 18 MΩ, which may be produced by Millipore Milli-Q water purification systems.

The extent of relief of the etched surface structures can be controlled by controlling the temperature and time of exposure to the etching agent, together with its concentration or the relative concentration of the components. For example, when utilising preferred etching agents such as hydrofluoric acid (20% aqueous solution by volume), an exposure time of between about 5 seconds to about 10 hours, preferably between about 10 seconds to about 2 hours, more preferably between about 20 seconds to about 20 minutes, still more preferably between about 30 seconds and about 5 minutes and most preferably between about 1 minute and 2 minutes is used for etching at room temperature of 21° C. The etching rate is dependent on the specific acids used, their concentrations and temperature. The etching process may be quenched by removing the etching agent from the fibre tip and this may for example be achieved by washing with distilled water or another suitable solvent. A preferred washing method comprises the steps of sequentially rinsing in deionised water, acetone and methanol. The fibre may then be blown dry with particulate free air or gas.

A thin film of metal may be deposited over the etched surface for example using a thermal evaporation coating unit (such as an Emitech K950x Turbo Evaporator) which uses a resistively heated tungsten element in the form of a conical basket to hold the metal and evaporate it in a vacuum. During the metal deposition the fibre can be clamped in position below and preferably normal to the metal containing basket of the unit. Preferably the fibre will be a distance of between about 40 mm and about 120 mm from the metal source. Other coatings methods such as electron beam evaporation and ion beam sputtering can also be used to generate thin metal films.

Most preferably the metal film will comprise gold, silver and/or copper although other metals such as aluminium, platinum, paladium, ruthenium, rhodium, nickel, cobalt, iron, lithium, indium, sodium, zinc, gallium and cadmium may also be used. For example, in the case of gold deposition a 0.2 mm diameter high-purity gold wire available from Goodfellow Corp. may be utilised as the gold source. The metal can be coated onto the surface in a complete thin film for example of thickness of between about 10 nm and about 1 μm, preferably between about 50 nm and about 500 nm and most preferably between about 80 nm and about 300 nm. The metal can also be deposited in a matrix formation (eg. where low points of the etched surface are covered but where high points of the etched surface penetrate through the metal coating) or in discrete particles for example on low or high points of the etched surface. For example discrete particles of metal can be deposited on high points of the etched surface by having the fibre tip angled to the metal source during deposition, rather than perpendicular.

Vapour deposition units may include a quartz crystal microbalance (such as the Emitech K150x Film Thickness Monitor) for monitoring deposition film thickness. Film thickness may also be approximated by calculating the length of metal required to achieve a desired layer thickness. The thickness of metal on the actual substrate can readily be confirmed by means of atomic force microscopy (AFM) or scanning electron microscopy.

The metallic film can exhibit useful optical properties due to its roughness, or the coating can be annealed in such a way that the metal coalesces into isolated particles. Thermal annealing serves to increase the mobility of metal atoms on the etched surface. For example, the particles in a thin film of gold can be reshaped by annealing at temperatures up to about 800° C. for periods of approximately 4 minutes. In this way it is possible to generate preferred particle shapes, such as a regular distribution of metal particles in the etched pits. Alternatively, the fibre can be arranged at an angle to the direction of coating deposition, in which case, only the highest points on the surface are coated. This approach is also known to produce isolated metal particles.

The homogeneity of the surface features and the resultant metal film provides superior reproducibility and stability, while the etching allows inexpensive production from the drawn fibre. Optical fibres are a technologically important platform in that they allow the optical properties of the film or particles to be exploited in a variety of sensing modalities. Gold and silver are the most commonly used metals, although as mentioned above, several others also demonstrate the properties of interest. Apart from surface-enhanced Raman scattering, Haes and Van Duyne report that these structures are also compatible with a sensing method based on UV-visible extinction spectroscopy, which requires less sophisticated equipment¹⁶

It is to be understood that the present invention applies not only to methods of generating ordered deposition geometries on transverse surfaces of an optical fibre or other articles having similar characteristics, but similarly to the optical fibres or articles thereby produced, and specifically to these articles which may be used as chemical sensors, for example in Raman spectroscopy, or indeed other forms of spectroscopy such as UV-visible extinction spectroscopy¹⁶. The optical fibres having ordered deposition geometry on tips thereof produced according to the invention are characterised by having individual optical elements with diameter of less than about 1000 nm, preferably less than about 500 nm and most preferably less than about 300 nm down to about 10 nm. In this way the fibres of the invention are able to act as optically homogeneous waveguides, or arrays of optically homogeneous waveguides.

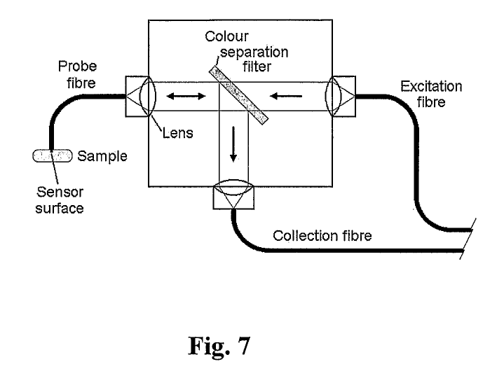

A fully integrated fibre-based probe can be used to obtain a compact, simple and alignment free sampling system. The so-called optrode design shown in FIG. 7 uses a single fibre to carry both the excitation radiation to the sample and the returning Raman scattered light. This sensor stub is kept as short as practically possible in order to reduce the background of Raman scattering from the fibre itself. A colour separation filter (or equivalent optical components) after the delivery fibre ensures that only light at the excitation wavelength reaches the sample. At the same time the filter reflects light in the Raman band of wavelengths towards the collection fibre. This reduces the unshifted light that could generate fibre Raman or fluorescence between sample and spectrometer. The key elements of the sensor of chemical and/or biological agents according to the invention are the compound optical fibre (referred to as the sensor surface in FIG. 7), which is in optical communication with a source of laser illumination, for example from a SpectraPhysics model 127 helium-neon laser (wavelength 633 nm), or other similar device. The compound optical fibre will also be in optical communication with a spectrometer and photodetector that can detect LSPR or other optical events via illumination transmitted to it.

The spectrometer is used to analyse the spectrum of the Raman scattered light. Typical spectrometers used for this purpose rely on a diffraction grating or a volume phase holographic grating to disperse the light into its spectral components. In some cases an acoustooptic modulator may be used for this purpose, or passband filters can be used to select spectral regions. Similar devices may be used to analyse the spectral distribution from a broadband light source that is reflected from or transmitted through the sensitised fibre tip.

The spectral distribution produced by the spectrometer is converted to an electrical signal by a photodetector. In addition to charge-coupled devices (CCDs), other suitable detectors include photomultiplier tubes, photodiodes, photodiode arrays and complementary metal oxide semiconductor (CMOS) detectors. Other conventional optical elements such as lenses and filters may also be incorporated within the sensor apparatus.

The sensor according to the invention may be utilised to detect the presence and composition of a variety of chemical and/or biological samples or agents, such as drugs, toxins, industrial products, food and beverage products and odours, environmental samples (e.g. water or air), enzymes, chemical reagents, proteins, sugars, peptides, nucleic acids or microorganisms such as bacteria, virus particles or the like. The fibre tips produced according to the invention can readily be functionalised by chemical methods that are well known to those of skill in the art. The functionalisation is performed in a manner that enables the introduction of one or more analyte specific agents onto the metal layer, matrix or particles of the tip. The analyte specific agents may be any molecule or species which can be attached to the metal layer and specifically includes bioactive agents such as proteins, nucleic acids, peptides, saccharides, fatty acids, steroids, purines, pyrimidines, as well as derivatives, structural analogues or combinations thereof. In a preferred embodiment, the functionalised coating is used to detect the presence or absence of a particular target analyte, where for example target analytes of interest include a particular nucleotide sequence or protein, such as an enzyme, an antibody or an antigen. In an alternate preferred embodiment, the functionalised coating is used to screen bioactive agents, such as drug candidates, for binding to a particular target analyte. The selectivity of the functionalised coating is based on the presence of functional groups, such as amine, carbonyl, hydroxyl or carboxyl groups, that allow structural interaction with the target analyte. The interaction may be mediated by hydrogen bonding.

The analyte specific agents may allow the introduction of an increased concentration of analyte in the vicinity of the fibre tip or may indeed exclude specific analytes or analyte classes from the vicinity adjacent to the fibre tip. Specific examples of analyte specific agents that may be adopted according to the invention include a self-assembled monolayer of (1-mercaptoundeca-11-yl)tri(ethylene glycol) for use in a glucose biosensors¹⁵ and G-protein coupled receptors²¹ for drug discovery or artificial nose applications.

A number of possible partition layers are known to be useful in preconcentrating analyte molecules, including absorbent polymers, self-assembled monolayers of organic molecules, liquid crystals, Langmuir-Blodgett-deposited phospholipids and fatty acids, covalently bound organic molecules, crown ethers, non-volatile organic molecules, metal complexes, or combinations of these. Some exemplary polymers include functionalised polysiloxanes, metal complex-modified siloxane polymer, γ-cyclodextrin derivatives dissolved in a polysiloxane matrix, conducting polymers (such as polyacetylene, polythiophene, polypyrrole or polyaniline), polymer emulsions, cellulose derivatives, plasma-deposited organic films (including plasma-polymerized and plasma-grafted films), enantiomers and dendrimers. Examples of self-assembled monolayers include layers composed of 4-aminothiophenol, L-cystein, 3-mercaptopropionic acid, 11-mercaptoundecanoic acid, 1-hexanethiol, 1-octanethiol, 1-decanethiol, 1-hexadecanethiol, poly-DL-lysine, 3-mercapto-1-propanesulfonic acid, benzenethiol, cyclohexylmercaptan and (1-mercaptoundeca-11-yl)tri(ethylene glycol).

The partitioning properties of a polymer coating depend on factors such as morphology, pore size, molecular weight or conjugation length, connectivity of monomers, flexibility, polarity and hydrophobicity. Consequently, it will be appreciated that the partitioning properties of a polymeric layer can be varied over a wide range through the substitution of different side groups and fillers and the use of different reaction conditions. Polymerisation conditions can be varied by changing the temperature, solvent, monomer concentration and many other factors appropriate to specific polymers.

In a preferred embodiment, the metal layer coated on the surface with relief is allowed to react directly with the target analyte e.g. to form an oxide. In another preferred embodiment, the metal layer coated on the surface with relief is coated with another metal or metal oxide layer, which is allowed to react with the target analyte. The second layer might consist of, for example, platinum, palladium, iridium, tin oxide, or tin oxide doped with platinum or palladium.

The analyte specific agents, partitioning layers or reactive coatings can be attached to the metal surface by means of several different chemical interactions. A variety of intermolecular forces govern the interactions between neutral closed-shell atoms and molecules. These include ion-ion, ion-dipole, dipole-dipole and London interactions and hydrogen bonding. These forces govern the adhesion of many polymers, metals, metal oxides and other molecules to a metal surface. In particular, thiol and amine groups are known to be strongly adsorbed onto gold and silver surfaces. This allows the attachment of additional chemically reactive groups that have a particularly strong affinity for a matching functional group on the molecule or particle to be attached. In this way, layers of linking agents can be built up and used to attach the analyte specific agents, partitioning layers or reactive coatings to the metal surface by means of covalent bonding. Examples of surface chemistries that facilitate the attachment of the desired coating functionality include chemistries based on amine, carboxylic acid, aldehyde, aliphatic amine, amide, chloromethyl, hydrazide, hydroxyl, sulphate, sulphonate and aromatic amine groups. These various attachment methods are generally known in the art.

In another embodiment, the target analyte is preconcentrated by a solid phase sorbent material or a membrane separator, before being delivered to the metal coating, which could also be functionalised in any of the ways described above. Examples of solid phase sorbent materials include activated charcoal, silica gel, alumina gel, magnesium-silica gel, porous polymers (such as Tenax), molecular sieves, and sorbents that have been coated with a layer of a selective reagent. After the sample has been concentrated on the sorbent material, it is released by thermal desorption or extracted into a suitable solvent. The technique of cryofocusing is also known, where a sample is preconcentrated by trapping on a cooled surface. The concentrated sample is then expelled by fast thermal desorption, where the trapping surface is heated at a rate of several thousand degrees Celsius per second. Examples of membrane separators include microporous silicone, polytetrafluoroethylene (PTFE) or polypropylene membrane. The membrane allows preferential penetration of different gaseous components by diffusion.

In cases where the target analyte or analytes do not provide a sufficiently strong SERS spectrum or other optical signature on their own, a functional group or molecule with a strong SERS spectrum or other optical signature may be attached to the analyte as a label. An example of this approach is given in Ref. 14, where Rhodamine B and Rhodamine 110 were attached to DNA via a labile succinimidyl intermediate. The vibrational bands of the SERS spectrum are inherently sharper than those of conventional fluorescent labels, which may be useful for the simultaneous detection of multiple probes.

It should be understood that the target analyte or analytes envisaged in the aforementioned embodiments could be present in either gas or vapour phase, or in solution.

The present invention will now be described further with reference to the following non-limiting examples.

### EXAMPLE 1

### Preparation of Compound Fibre with Ordered Deposition Geometry on Fibre Tip

A commercial silica image fibre from Fujikura Asia Ltd was used in this work (FIGH-10-350S having 9,450 pixels, 350 μm total outer diameter and 3.2 μm spacing between pixels). Acetone (99% pure) was used to remove the polymeric fibre buffer coating as well as traces of oils, dust or other contamination from a section of the fibre. The cleaned section of the fibre was then heated in a flame from an oxyacetylene torch and was drawn by the weight of a clamp attached to the fibre beneath the flame. In this way, the fibre was drawn down to an external diameter of about 5 μm. The fibre was cleaved on the tapered section at a diameter of approximately 30 μm using a standard optical fibre cleaver (Fitel S-311). The diameter was measured under a calibrated optical microscope and confirmed after cleaving in an SEM.

The fibre tip was then etched using an etching agent comprising either (a) a solution of 20% by volume hydrofluoric acid (HF) in water for a period of 15 minutes; or (b) a buffered HF solution (BHF) consisting of 6 parts 40% ammonium fluoride (NH₄F), 1 part 49% hydrofluoric acid (HF) and 14 parts 49% hydrochloric acid (HCl) for 2 minutes. The ratio of reagents in the buffered HF equates to approximately 5:1:14:23 (NH₄F:HF:HCl:H₂O). After etching for the specified time, the fibre was rinsed with de-ionised water. The etched relief on the fibre tip was then inspected with a Philips XL30 scanning electron microscope with an acceleration voltage of 20 kV. To facilitate SEM inspection, the fibre was coated with a thin layer (about 5 nm) of gold in a plasma sputter coater.

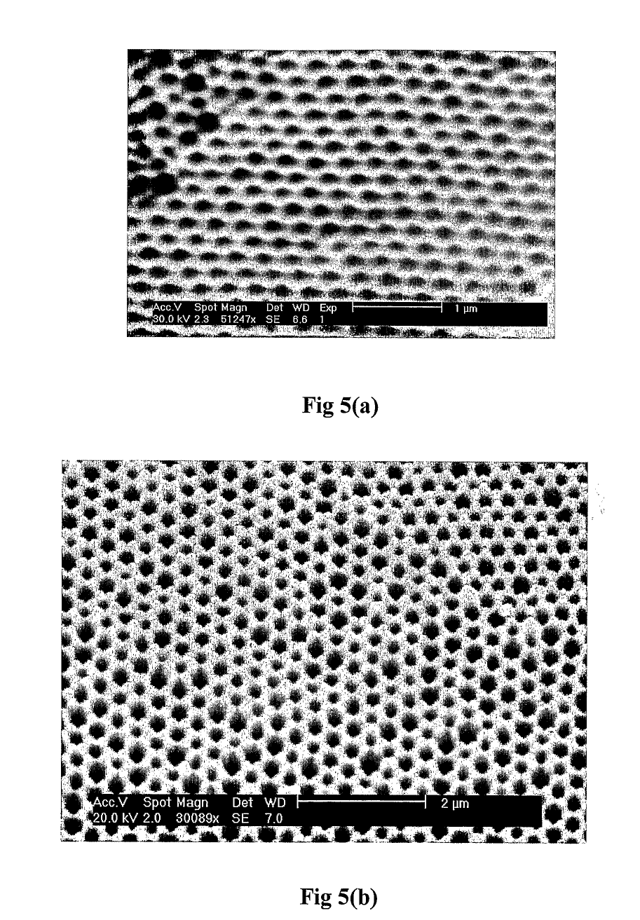

The etching agents dissolve the doped silica, which comprises the core of the individual fibres, faster than they dissolve the fluorine doped silica cladding of the individual fibres. As a result of this preferential etching, a “honeycomb” structure is created, as shown in FIG. 5(a) for etching agent (a) and FIG. 5(b) for etching agent (b). This reveals the original arrangement of the individual fibres that comprise the fibre bundle. The relief of the etched structures can be controlled by means of the etching time. In FIG. 5(b), the borders between the pits also display some relief. This structure is the result of variations in the effective thickness of the fused cladding between the individual fibres, leading to different attrition rates during etching. We note that this relief may also be of value for generating the localised surface plasmon resonance.

A thin film of silver was then deposited over the etched surface using an Emitech K950x Turbo Evaporator thermal evaporation coating unit, which uses a tungsten element to evaporate the metal in a vacuum. During the metal deposition the fibre was clamped in position directly below the silver containing tungsten basket, which is resistively heated. The unit includes a quartz crystal microbalance (Emitech K150x Film Thickness Monitor) for monitoring the film thickness. In this way, a 0.2 mm diameter high-purity silver wire from ProSciTech was used to deposit a 100 nm layer of silver.

### EXAMPLE 2

### Surface Enhanced Raman Scattering Measurement

The inventor has demonstrated the utility of the present invention by performing surface enhanced Raman scattering (SERS) measurements using fibre tips prepared according to Example 1 (using etching agents (a) and (b)). Raman scattering is observed when light is inelastically scattered by vibrating molecules, resulting in a shift to both higher and lower frequencies. The Raman-active vibrational frequencies of the molecules provide a characteristic fingerprint of the species present. At the same time, Raman spectroscopy can be applied in aqueous media because of the small scattering cross section of water. Scattering may be enhanced by a factor greater than 10⁶ for molecules adsorbed on a surface to which a thin metal deposit has been applied. As a result, SERS provides a good indication of the optical properties of the fibre tip.

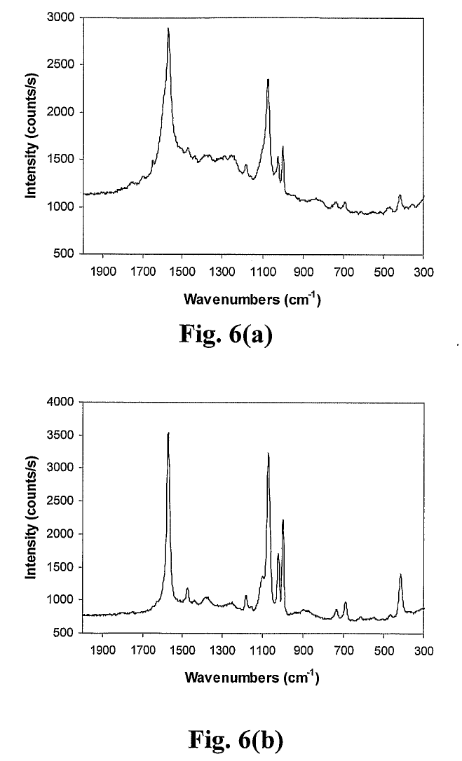

SERS analysis was conducted using an etched fibre tip to which a 100 nm layer of silver was applied in a vapour deposition system. The coated fibre tip was soaked in a 10 mM solution of thiophenol in ethanol. Thiophenol (benzenethiol, >99%) was obtained from Aldrich and ethanol (puriss., 99.8% GC) was purchased from Riedel-de Haën. All chemicals were used without further purification. Thiophenol serves as a convenient reference compound for SERS analysis, as it forms relatively stable monolayers on gold and silver surfaces. The resulting SERS spectra are shown in FIGS. 6(a) and 6(b), for etchants (a) and (b) of Example 1, respectively. The main thiophenol SERS peaks at 420, 1000, 1025, 1075 and 1575 cm⁻¹ are readily visible. The relatively high count rates are indicative of surface enhancement. Detailed aspects of the spectra, such as peak widths, relative peak heights and background levels, are believed to be effected by the power level of the laser excitation, excitation wavelength and the structure of the metal coating. In the present examples, it is believed that the differences between FIGS. 6(a) and 6(b) are primarily the result of structural effects.

Raman spectra were obtained using a Renishaw System RM2000, fitted with a thermoelectrically cooled, NIR enhanced (deep depletion) CCD detector. A SpectraPhysics Model 127 helium-neon laser (wavelength 633 nm) was used to excite the spectra; this was filtered by a notch filter to reject plasma lines. Samples were examined under an Olympus BH2 microscope, which allowed the identification of the coated fibre tips. Spectra were collected from the selected region in a back scattering geometry through a ×20 objective. The laser power at the sample was about 0.5 mW; integration times were 10 seconds with five accumulations in each case.

### REFERENCES

1. M. Roukes, “Plenty of room indeed”, Sci. Am. 285, pp 42-49, 2001.
2. R. Weisendanger, “Future nanosensors”, Sensors: A comprehensive survey, ed. by W. Göpel, J. Hesse and J. N. Zemel, Vol. 8, pp 337-356, VCH, Weinheim, 1995.
3. C. L. Haynes and R. P. Van Duyne, “Nanosphere lithography: a versatile nanofabrication tool for studies of size-dependent nanoparticle optics”, J. Phys. Chem. 105, pp 5599-5611, 2001.
4. M. Moskovits, “Surface-enhanced spectroscopy,” Rev. Mod. Phys. 57, pp 783-826, 1985.
5. G. C. Schatz and R. P. Van Duyne, “Electromagnetic mechanism of surface-enhanced spectroscopy,” in Handbook of Vibrational Spectroscopy, ed. by J. M. Chalmers and P. R. Griffiths, Wiley, New York, 2002.
6. Z. Q. Tian, “Surface-enhanced Raman spectroscopy: its present status,” Int. J. Vib. Spect. [www.ijvs.com] 4, 2, 2000.
7. P. F. Liao, J. G. Bergman, D. S. Chemla, A. Wokaun, J. Melngailis, A. M. Hawryluk, and N. P. Economou, “Surface enhanced Raman scattering from microlithographic silver particle surfaces,” Chem. Phys. Lett. 82, 355, 1981.
8. M. Kahl, E. Voges and W. Hill, “Optimisation of SERS substrates by electron-beam lithography,” Spectrosc. Europe 10/6, pp 8-13, 1998.
9. C. L. Haynes, A. J. Haes and R. P. Van Duyne, “Nanosphere lithography: synthesis and application of nanoparticles with inherently anisotropic structures and surface chemistry”, Mat. Res. Soc. Symp. Proc. 635, pp C6.3/1-C6.3/6, 2001.
10. I. R. Lewis and H. Owen, “Raman Spectroscopy Steps into the Pharmaceutical Arena,” Biophotonics Int. 8, pp 46-52, 2001.
11. C. Viets and W. Hill, “Fibre-optic SERS sensors,” Int. J. Vib. Spect. [www.ijvs.com] 4, 8, 2000.
12. W. Göpel, “Sensors and ‘smart’ molecular nanostructures: components for future information technologies”, Sensors: A comprehensive survey, ed. by W. Göpel, J. Hesse and J. N. Zemel, Vol. 8, pp 337-356, VCH, Weinheim, 1995.
13. W. Hill, V. Fallourd, and D. Klockow, “Investigation of the adsorption of gaseous aromatic compounds at surfaces coated with heptakis(6-thio-6deoxy)—cyclodextrin by surface-enhanced Raman scattering,” J. Phys. Chem. B 103, pp 4707-4713, 1999.
14. T. Vo-Dinh, L. R. Allain and D. L. Stokes, “Cancer gene detection using surface-enhanced Raman scattering (SERS)”, J Raman Spectrosc. 33 (2002) 511-516.
15. C. R. Yonzon, et al., “A glucose biosensor based on surface-enhanced Raman scattering: improved partition layer, temporal stability, reversibility, and resistance to serum protein interference”, Anal. Chem. 76 (2004) 78-85.
16. A. J. Haes and R. P. Van Duyne, “A nanoscale optical biosensor: sensitivity and selectivity of an approach based on the localized surface plasmon resonance spectroscopy of triangular silver nanoparticles,” J. Am. Chem. Soc. 124, pp 10596-10604, 2002
17. E. Polwart, R. L. Keir, C. M. Davidson, W. E. Smith, and D. A. Sadler, “Novel SERS-active optical fibres prepared by the immobilization of silver colloidal particles,” Appl. Spectrosc. 54 (2000) 522-526.
18. T. Murphy, S. Lucht, H. Schmidt, and H.-D. Kronfeldt, “Surface-enhanced Raman scattering (SERS) system for continuous measurements of chemicals in sea water,” J Raman Spectrosc. 31 (2000) 943-948.
19. R. Micheletto, H. Fukuda, and M. Ohtsu, “A simple method for the production of a two-dimensional, ordered array of small latex particles,” Langmuir 11, pp 3333-3336, 1995.
20. D. Pinkel and J. Gray, “High density array fabrication and readout method for a fiber optic biosensor”, U.S. Pat. No. 5,690,894 (11/1997).
21. C. Bieri, et al., “Micropatterned immobilization of a G protein-coupled receptor and direct detection of G protein activation”, Nature Biotech. 17 (1999) 1105-1108.

1. A method of generating an ordered deposition geometry on a surface of a compound optical fiber, comprising:
(a) arranging a plurality of optical fibers and/or compound optical fibers in common orientation and close packed configuration to form a bundle;
(b) drawing the bundle under suitable conditions to produce a compound optical fiber of a desired diameter;
(c) processing the compound optical fiber to produce a substantially planar surface;
(d) subjecting the surface to an etching agent to produce surface relief; and
(e) subjecting the surface with relief to metal coating.

2. The method according to claim 1, wherein (a) and (b) are repeated consecutively 1 to 4 times prior to conducting (c).

3. The method according to claim 1, further comprising cleaving and/or grinding optical fiber and/or compound optical fiber to desired length.

4. The method according to claim 1, wherein the substantially planar surface is substantially transverse to compound optical fiber longitudinal axis.

5. The method according to claim 1, wherein an optical fiber compatible support of desired configuration is used to retain optical fibers and/or compound optical fibers in (a).

6. The method according to claim 5, wherein the support comprises a silicate glass.

7. The method according to claim 5, wherein the support is collapsed under heat and/or vacuum to form the bundle.

8. The method according to claim 1, wherein processing to produce the substantially planar surface comprises cleaving and/or grinding.

9. The method according to claim 1, wherein the etching agent is an acid or alkaline solution.

10. The method according to claim 1, wherein the etching agent comprises at least one of hydrofluoric acid, hydrochloric acid, acetic acid, sulfuric acid, citric acid, boric acid, nitric acid, phosphoric acid, benzoic acid, butanoic acid, carbonic acid, formic acid, hydrogen sulfide, hydrocyanic acid, oxalic acid, perchloric acid, potassium hydroxide, phosphoric acid, propanoic acid, trichloro acetic acid, sodium hydroxide, hydrogen peroxide, magnesium hydroxide, potassium hydroxide, ammonium fluoride and ammonia.

11. The method according to claim 1, wherein the surface is subjected to the etching agent for a period of between about 5 seconds and about 10 hours.

12. The method according to claim 1, wherein the surface is subjected to the etching agent for a period of between about 10 seconds to about 2 hours.

13. The method according to claim 1, wherein the surface is subjected to the etching agent for a period of between about 20 seconds to about 40 minutes.

14. The method according to claim 1, wherein the surface is subjected to the etching agent for a period of between about 30 seconds and about 10 minutes.

15. The method according to claim 1, wherein the surface is subjected to the etching agent for a period of between about 1 minute and about 5 minutes.

16. The method according to claim 1, further comprising performing quenching after the surface has been exposed to the etching agent.

17. The method according to claim 16, wherein the quenching involves rinsing with distilled water.

18. The method according to claim 16, wherein the quenching is assisted by agitation in an ultrasonic bath.

19. The method according to claim 1, wherein the metal utilized in the metal coating comprises at least one of gold, silver, copper, aluminum, platinum, lithium, indium, sodium, zinc, gallium and cadmium.

20. The method according to claim 1, wherein the metal is coated onto the surface in a thin film, in a matrix formation or in discrete particles.

21. The method according to claim 1, wherein the metal is coated onto the surface in a matrix formation.

22. The method according to claim 1, wherein the metal is coated onto the surface in discrete particles.

23. The method according to claim 1, wherein the metal layer has a thickness of between about 10 nm and about 1 μm.

24. The method according to claim 1, wherein the metal layer has a thickness of between about 50 nm and about 500 nm.

25. The method according to claim 1, wherein the metal layer has a thickness of between about 80 nm and about 300 nm.

26. The method according to claim 1, wherein the surface with relief is coated with multiple layers of metal.

27. The method according to claim 1, wherein a layer of chrome is applied to the surface with relief to improve adhesion to the surface of subsequent metal layers.

28. The method according to claim 1, wherein metal is deposited at high points of the surface with relief.

29. The method according to claim 1, wherein metal is deposited at low points of the surface with relief.

30. The method according to claim 1, wherein a metal layer coated on the surface with relief is functionalized to allow chemical binding to analyte specific agents.

31. The method according to claim 30, wherein the metal layer coated on the surface with relief is functionalized with an agent that selectively concentrates a target analyte or analytes at the sensor surface.

32. The method according to claim 1, wherein the compound optical fiber with ordered deposition geometry on a surface thereof is coherent.

33. The method according to claim 1, wherein individual optical elements of the compound optical fiber have a diameter less than about 1000 nm.

34. The method according to claim 1, wherein individual optical elements of the compound optical fiber have a diameter less than about 500 nm.

35. The method according to claim 1, wherein individual optical elements of the compound optical fiber have a diameter less than about 300 nm.

36. The method according to claim 1, wherein the compound optical fiber is an optically homogenous waveguide.

37. A compound optical fiber with an ordered deposition geometry on a substantially planar surface thereof, produced by a method of generating an ordered deposition geometry on a surface of a compound optical fiber, wherein the method comprises:
(a) arranging a plurality of optical fibers and/or compound optical fibers in common orientation and close packed configuration to form a bundle;
(b) drawing the bundle under suitable conditions to produce a compound optical fiber of a desired diameter;
(c) processing the compound optical fiber to produce a substantially planar surface;
(d) subjecting the surface to an etching agent to produce surface relief; and
(e) subjecting the surface with relief to metal coating.

38. A compound optical fiber having an ordered deposition geometry on a substantially planar surface that is substantially transverse to compound optical fiber longitudinal axis, wherein the compound optical fiber comprises individual optical elements of less than about 1000 nm in diameter.

39. A compound optical fiber having an ordered deposition geometry on a substantially planar surface thereof, for use as a sensor of chemical and/or biological agents.

40. A sensor of chemical and/or biological agents comprising a laser or broadband light source, a spectrometer and a photodetector that are in optical communication with a compound optical fiber having an ordered deposition geometry on a substantially planar surface thereof.
